(19) United States
(12) Patent Application Publication
(10) Pub. No.: US 2023/0395939 A1
(43) Pub. Date: Dec. 7, 2023

(54) LITHIUM SECONDARY BATTERY

(71) Applicant: TeraWatt Technology K.K., Yokohama-shi (JP)

(72) Inventors: Ken Ogata, Yokohama-shi (JP); Hiroshi Imoto, Yokohama-shi (JP); Masatsugu Nakano, Yokohama-shi (JP)

(73) Assignee: TeraWatt Technology K.K., Yokohama-shi (JP)

(21) Appl. No.: 18/111,337

(22) Filed: Feb. 17, 2023

Related U.S. Application Data
(63) Continuation of application No. PCT/JP2020/033590, filed on Sep. 4, 2020.

(30) Foreign Application Priority Data
Aug. 18, 2020 (WO) PCT/JP2020/031096

(51) Int. Cl. H01M 50/457; H01M 10/0525; H01M 10/0585; H01M 50/497; H01M 50/426; H01M 50/491; H01M 4/66; H01M 50/431

(52) U.S. Cl. CPC H01M 50/457; H01M 10/0525; H01M 10/0585; H01M 50/497; H01M 50/426; H01M 50/491; H01M 4/661; H01M 50/431; H01M 2004/027

(57) ABSTRACT

The purpose of the present invention is to provide a lithium secondary battery which has a high energy density and an excellent cycle characteristic and is suppressed from a volumetric change of a cell due to charge/discharge. The present invention relates to a lithium secondary battery having a positive electrode, a negative electrode not having a negative-electrode active material, a separator or a solid electrolyte placed between the positive electrode and the negative electrode, and a fibrous or porous buffering function layer formed on the surface of the separator or the solid electrolyte facing the negative electrode, the buffering function layer having ionic conductivity and electronic conductivity.

### BACKGROUND

### Field

The present invention relates to a lithium secondary battery.

### Description of Related Art

The technology of converting natural energy such as solar light and window power into electric energy has recently attracted attentions. Under such a situation, various secondary batteries have been developed as a highly-safe power storage device capable of storing a lot of electric energy.

Among them, secondary batteries which perform charge/discharge by transferring metal ions between a positive electrode and a negative electrode are known to exhibit a high voltage and a high energy density. Typically, lithium-ion secondary batteries are known. Examples of the typical lithium-ion secondary batteries include those which have a positive electrode and a negative electrode having, introduced thereon, an active material capable of retaining lithium and perform charge/discharge by delivering or receiving lithium ions between a positive-electrode active material and a negative-electrode active material. In addition, as a secondary battery having a negative electrode for which no active material is used, there has been developed a lithium-metal secondary battery which precipitates a lithium metal on the surface of a negative electrode and thereby retaining lithium thereon.

For example, Patent Document 1 discloses a high-energy-density and high-output lithium-metal anode secondary battery having a volume energy density exceeding 1000 Wh/L and/or a mass energy density exceeding 350 Wh/kg at the time of discharge at at least a rate of 1C at room temperature. Patent Document 1 discloses the use of an ultrathin lithium-metal anode for manufacturing such a lithium-metal anode secondary battery.

Patent Document 2 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode when the battery is charged, to form lithium metal on the negative electrode current collector in the negative electrode. Patent Document 2 discloses that such a lithium secondary battery shows the possibility of providing a lithium secondary battery which has overcome the problem due to the reactivity of the lithium metal and the problem caused during assembly and therefore has improved performance and service life.

### PATENT DOCUMENTS

Patent Document 1: Published Japanese Translation of PCT application No 2019-517722

Patent Document 2: Published Japanese Translation of PCT application No 2019-537226

### SUMMARY

As a result of detailed investigation of conventional batteries including those described in the above patent documents, the present inventors have found that at least either one of their energy density and cycle characteristic is not sufficient.

For example, a typical secondary battery which carries out charge/discharge by delivering or receiving metal ions between a positive-electrode active material and a negative-electrode active material does not have a sufficient energy density. A conventional lithium-metal secondary battery which precipitates a lithium metal on the surface of a negative electrode and thereby retains lithium thereon, as described in the aforesaid patent document, is likely to form a dendrite-like lithium metal on the surface of the negative electrode after repetition of charge/discharge and cause a short circuit and capacity reduction. This results in an insufficient cycle characteristic.

In a lithium-metal secondary battery, a method of applying a large physical pressure on a battery to keep the interface between a negative electrode and a separator at high pressure has also been developed in order to suppress the discrete growth at the time of lithium metal precipitation. Application of such a high pressure however needs a large mechanical mechanism, leading to an increase in the weight and volume of the battery and a reduction in energy density as the entire battery.

Further, the conventional lithium-metal secondary battery has such a drawback that a volumetric change of a cell (entire battery) caused by charging/discharging is large due to the precipitation of a lithium metal on the surface of a negative electrode.

The present invention has been made in consideration of the aforesaid problems and a purpose is to provide a lithium secondary battery having a high energy density and an excellent cycle characteristic, and suppressed from causing a volumetric change of a cell due to charging/discharging.

The lithium secondary battery according to one embodiment of the present invention has a positive electrode, a negative electrode not having a negative-electrode active material, a separator placed between the positive electrode and the negative electrode, and a fibrous or porous buffering function layer formed on the surface of the separator facing the negative electrode, the buffering function layer having ionic conductivity and electronic conductivity.

Such a lithium secondary battery equipped with a negative electrode not having a negative-electrode active material has a high energy density because a lithium metal precipitates on the surface of the negative electrode and charge/discharge are performed by depositing lithium metal on the surface of the negative electrode and electrolytically dissolving the deposited lithium. In addition, the buffering function layer is fibrous or porous, so that a lithium metal which precipitates on the negative electrode by charging can precipitate so as to fill the pores of the buffering function layer with it and a volumetric change of a cell following charging/discharging can be suppressed. Further, in the lithium secondary battery, the buffering function layer has ionic conductivity and electronic conductivity, a lithium metal can precipitate not only on the surface of the negative electrode but also on the inside of the buffering function layer. This increases the surface area of a reaction site of a lithium metal precipitation reaction and a reaction rate of the lithium metal precipitation reaction is controlled to be mild. As a result, growth of a lithium metal on the negative electrode into a dendrite form is suppressed.

A solid electrolyte may be used instead of the separator. In such a mode, a lithium secondary battery can be used as a solid battery and such a lithium secondary battery has higher safety.

The porosity of the buffering function layer is preferably 70% or more and 95% or less. In such a mode, the aforesaid buffering function layer exhibits its effect more effectively and reliably and the resulting lithium secondary battery has a more improved cycle characteristic and energy density.

The thickness of the buffering function layer is preferably 1 μm or more and 100 μm or less. In such a mode, the aforesaid buffering function layer exhibits its effect more effectively and reliably and the resulting lithium secondary pattern has a more improved cycle characteristic and energy density.

The buffering function layer may include a fibrous or porous ionically conductive layer and an electronically conductive layer which covers the ionically conductive layer therewith. In such a mode, a lithium ion in the ionically conductive layer causes a reduction reaction by electrons supplied from the electronically conductive layer, which causes precipitation of a lithium metal. In addition, the lithium metal thus precipitated releases electrons to the electronically conductive layer and is thereby dissolved as a lithium ion in the ionically conductive layer.

The average thickness of the aforesaid electronically conductive layer is preferably 1 nm or more and 300 nm or less. In such a mode, the buffering function layer can keep its electronic conductivity more appropriately, so that the resulting lithium secondary battery has a more improved cycle characteristic.

The aforesaid lithium secondary battery is a lithium secondary battery in which charging and discharging are performed by depositing lithium metal on the surface of the negative electrode and dissolving the deposited lithium. In such a mode, it has a higher energy density.

The negative electrode preferably consists of at least one selected from the group consisting of Cu, Ni, Ti, Fe, and other metals that do not react with Li, alloys thereof, and stainless steel (SUS). In such a mode, use of a lithium metal having high flammability is not required for the manufacture, so that a negative electrode having more excellent safety and productivity can be obtained. In addition, such a negative electrode is stable and therefore, a secondary battery obtained using it has an improved cyclic characteristic.

The aforesaid lithium secondary battery preferably has no lithium foil on the surface of the aforesaid negative electrode before initial charge. In such a mode, a lithium metal having high flammability is not required for the manufacture so that the resulting battery has more excellent safety and productivity.

The aforesaid lithium secondary battery has preferably an energy density of 350 Wh/kg or more.

The present invention makes it possible to provide a lithium secondary battery which has a high energy density and an excellent cycle characteristic and is suppressed from a volumetric change of a cell due to charge/discharge.

### BRIEF DESCRIPTION OF DRAWINGS

FIG. 1 is a schematic cross-sectional view of a lithium secondary battery according to First Embodiment.

FIG. 2 is a schematic cross-sectional view of the use of the lithium secondary battery according to First Embodiment.

FIG. 3 is a schematic cross-sectional view of a buffering function layer in the lithium secondary battery according to First Embodiment, in which (A) shows a fibrous buffering function layer which is one embodiment of a buffering function layer, (B) shows a precipitation mode of a lithium metal on the fibrous buffering function layer, and (C) shows one embodiment of a member constituting the fibrous buffering function layer.

FIG. 4 is a schematic cross-sectional view of a lithium secondary battery according to Second Embodiment.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. Further, a dimensional ratio in the drawings is not limited to the ratio shown in the drawings.

### First Embodiment

### (Lithium Second Battery)

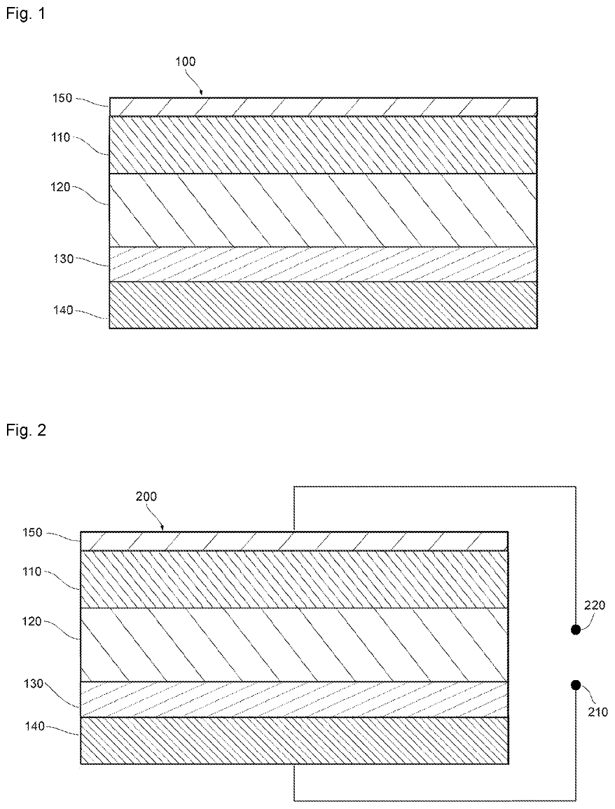

FIG. 1 is a schematic cross-sectional view of a lithium secondary battery of First Embodiment. As shown in FIG. 1, a lithium secondary battery 100 of First Embodiment includes a positive electrode 110, a negative electrode 140 not having a negative-electrode active material, a separator 120 placed between the positive electrode 110 and the negative electrode 140, and a fibrous or porous buffering function layer 130 formed on the surface of the separator 120 facing the negative electrode 140, the buffering function layer having ionic conductivity and electronic conductivity. The positive electrode 110 has a positive electrode current collector 150 on the surface thereof opposite to the surface facing the separator 120.

(Negative Electrode)

The negative electrode 140 does not have a negative-electrode active material. A lithium secondary battery including a negative electrode having a negative-electrode active material is hard to have an enhanced energy density due to the presence of the negative-electrode active material. On the other hand, the lithium secondary battery 100 of the present embodiment includes the negative electrode 140 not having a negative-electrode active material, so that it has no such a problem. In other words, the lithium secondary battery 100 of the present embodiment has a high energy density because charging and discharging are performed by depositing lithium metal on the surface of the negative electrode 140 and electrolytically dissolving the deposited lithium.

In the present embodiment, the term “a lithium metal precipitates on the negative electrode” means, unless otherwise specifically described, that a lithium metal precipitates on at least one of the surface of the negative electrode, the surface of a solid portion of the buffering function layer which will be described later, and the surface of a solid electrolyte interface (SEI) layer formed on the surface of the negative electrode and/or the surface of the solid portion of the buffering function layer. In the lithium secondary battery 100, therefore, the lithium metal may precipitate, for example, on the surface of the negative electrode 140 (the interface between the negative electrode 140 and the buffering function layer 130) or on the inside of the buffering function layer 130 (the surface of the solid portion of the buffering function layer).

The term “negative-electrode active material” as used herein means a material for retaining, on the negative electrode 140, a lithium ion or a lithium metal (which will hereinafter be called “carrier metal”) and it may be replaced by the term “host material of a carrier metal”. Such a retaining mechanism is not particularly limited and examples of it include intercalation, alloying, and occlusion of metal clusters, and it is typically intercalation.

Such a negative-electrode active material is not particularly limited and examples include carbon-based materials, metal oxides, and metals or alloys. The carbon-based material is not particularly limited and examples include graphene, graphite, hard carbon, mesoporous carbon, carbon nanotube, and carbon nanohorn. The metal oxide is not particularly limited and examples include titanium oxide-based compounds, tin oxide-based compounds, and cobalt oxide-based compounds. The metals or alloys are not particularly limited insofar as they can be alloyed with the carrier metal and examples include silicon, germanium, tin, lead, aluminum, and gallium and alloys containing them.

The negative electrode 140 is not particularly limited insofar as it does not have a negative-electrode active material and is usable as a current collector. Examples include electrodes consisting of at least one selected from the group consisting of Cu, Ni, Ti, Fe, and other metals that do not react with Li, alloys thereof, and stainless steel (SUS). When a SUS is used as the negative electrode 140, a variety of conventionally known SUSs can be used as its kind. One or more of the negative electrode materials may be used either singly or in combination. The term “metal that does not react with Li” as used herein means a metal which does not form an alloy under the operation conditions of the lithium secondary battery, reacting with a lithium ion or a lithium metal.

The negative electrode 140 is preferably an electrode containing no lithium. In such a mode, it can be manufactured without using a highly flammable lithium metal, so that the resulting lithium secondary battery 100 has higher safety and more excellent productivity. From a similar standpoint and the standpoint of obtaining a negative electrode 140 having improved stability, the negative electrode 140 more preferably consists of at least one selected from the group consisting of Cu and Ni, and an alloy thereof, and a stainless steel (SUS). From a similar standpoint, the negative electrode 140 still more preferably consists of Cu or Ni, or an alloy thereof and particularly preferably consists of Cu or Ni.

The term “negative electrode does not have a negative-electrode active material” as used herein means that the content of the negative-electrode active material in the negative electrode is 10 mass % or less based on the total amount of the negative electrode. The content of the negative-electrode active material in the negative electrode is preferably 5.0 mass % or less and it may be 1.0 mass % or less, 0.1 mass % or less, or 0.0 mass % or less, each based on the total amount of the negative electrode. The term “the lithium secondary battery 100 includes a negative electrode not having a negative-electrode active material” means that the lithium secondary battery 100 is, in a commonly used sense, an anode-free secondary battery, zero-anode secondary battery, or anode-less secondary battery.

In a typical lithium-ion secondary battery, the capacity of the negative-electrode active material in the negative electrode is set to be equal to that of the positive electrode. The lithium secondary battery 100 has a buffering function layer 130 between the negative electrode 140 and a separator 120. The aforesaid buffering function layer may contain a metal reactive with lithium but the capacity of the metal is sufficiently smaller than that of the positive electrode, so that the lithium secondary battery 100 can be said to “include a negative electrode not having a negative-electrode active material”.

The total capacity of the negative electrode 140 and the buffering function layer 130 is sufficiently small relative to the capacity of the positive electrode 110 and it may be, for example, 20% or less, 15% or less, 10% or less, or 5% or less. Each capacity of the positive electrode 110, the negative electrode 140, and the buffering function layer 130 can be measured by a conventionally known method.

The average thickness of the negative electrode 140 is preferably 4 μm or more and 20 μm or less, more preferably 5 μm or more and 18 μm or less, and still more preferably 6 μm or more and 15 μm or less. In such a mode, since the occupation volume of the negative electrode 140 in the lithium secondary battery 100 decreases, the lithium secondary battery 100 has a more improved energy density.

(Positive Electrode)

A positive electrode 110 is not particularly limited insofar as it is used generally for a lithium secondary battery and a known material can be selected as needed as a material used for the positive electrode, depending on the usage of the lithium secondary battery and kind of the carrier metal. From the standpoint of obtaining a lithium secondary battery having enhanced stability and output voltage, the positive electrode 110 preferably has a positive-electrode active material.

The term “positive-electrode active material” as used herein means a material for retaining a lithium (typically, a lithium ion) on the positive electrode 110 and the material may also be called a host material for lithium ion.

Such a positive-electrode active material is not particularly limited and examples include metal oxides and metal phosphates. The aforesaid metal oxides are not particularly limited and examples include cobalt oxide-based compounds, manganese oxide-based compounds, and nickel oxide-based compounds. The aforesaid metal phosphates are not particularly limited and examples include iron phosphate-based compounds and cobalt phosphate-based compounds. Examples of typical positive-electrode active materials include LiCoO₂, LiNiₓCo_{y}Mn_{z}O (x+y+z=1), LiNiₓMn_{y}O (x+y=1), LiNiO₂, LiMn₂O₄, LiFePO, LiCoPO, LiFeOF, LiNiOF, and TiS₂. One or more of the aforesaid positive-electrode active materials may be used either singly or in combination.

The positive electrode 110 may contain a component other than the aforesaid positive-electrode active material. Such a component is not particularly limited and examples include known conductive additives, binders, solid polymer electrolytes, and inorganic solid electrolytes.

The conductive additive to be contained in the positive electrode 110 is not particularly limited and examples include carbon black, single-wall carbon nanotube (SWCNT), multi-wall carbon nanotube (MWCNT), carbon nanofiber (CF), and acetylene black. The binder is not particularly limited and examples include polyvinylidene fluoride, polytetrafluoroethylene, styrene butadiene rubber, acrylic resins, and polyimide resins.

The content of the positive-electrode active material in the positive electrode 110 may be, for example, 50 mass % or more and 100 mass % or less based on the total amount of the positive electrode 110. The content of the conductive additive in the total amount of the positive electrode 110 may be, for example, 0.5 mass % or more and 30 mass % or less. The content of the binder in the total amount of the positive electrode 110 may be, for example, 0.5 mass % or more and 30 mass % or less. The sum of the contents of the solid polymer electrolyte and an inorganic solid electrolyte in the total amount of the positive electrode 110 may be, for example, 0.5 mass % or more and 30 mass % or less.

(Positive Electrode Current Collector)

The positive electrode 110 has, on one side thereof, a positive electrode collector 150. The positive electrode current collector 150 is not particularly limited insofar as it is a conductor not reactive with a lithium ion in the battery. Examples of such a positive electrode current collector include aluminum.

The average thickness of the positive electrode current collector 150 is preferably 4 μm or more and 20 μm or less, more preferably 5 μm or more and 18 μm or less, and still more preferably 6 μm or more and 15 μm or less. In such a mode, an occupation volume of the positive electrode current collector 150 in the lithium secondary battery 100 decreases and the resulting lithium secondary battery 100 therefore has a more improved energy density.

(Separator)

The separator 120 is a member for separating the positive electrode 110 from the negative electrode 140 to prevent a short circuit of the battery and in addition, for securing the ionic conductivity of a lithium ion which serves as a charge carrier between the positive electrode 110 and the negative electrode 140. It is composed of a material not having electronic conductivity and unreactive to lithium ion. The separator 120 also has a role of retaining electrolyte solution. No limitation is imposed on the separator 120 insofar as it plays the aforesaid role and examples include members composed of a porous polyethylene (PE) film and a polypropylene (PP) film, and a stacked structure of them.

The separator 120 may be covered with a separator coating layer. The separator coating layer may cover both of the surfaces of the separator 120 or may cover only one of them. The separator coating layer is not particularly limited insofar as it is a member having ionic conductivity and unreactive to a lithium ion and is preferably capable of firmly adhering the separator 120 to a layer adjacent to the separator 120. Such a separator coating layer is not particularly limited and examples include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may be a member obtained by adding, to the aforesaid binder, inorganic particles such as silica, alumina, titania, zirconia, magnesium oxide, magnesium hydroxide, or lithium nitrate. The separator 120 embraces a separator having a separator coating layer.

The average thickness of the separator 120 is preferably 40 μm or less, more preferably 35 μm or less, and still more preferably 30 μm or less. In such a mode, the occupation volume of the separator 120 in the lithium secondary battery 100 decreases and therefore, the resulting lithium secondary battery 100 has a more improved energy density. The average thickness of the separator 120 is preferably 5 μm or more, more preferably 7 μm or more, and still more preferably 10 μm or more. In such a mode, the positive electrode 110 can be separated from the negative electrode 140 more reliably and the short circuit of the battery can be prevented further.

(Buffering Function Layer)

The buffering function layer 130 is formed on the surface of the separator 120 facing the negative electrode 140. The buffering function layer 130 is fibrous or porous and has ionic conductivity and electronic conductivity. Since the buffering function layer 130 is placed between the separator 120 and the negative electrode 140 in the present embodiment, when the lithium secondary battery 100 is charged, the surface and/or inside of the buffering function layer 130 is supplied with electrons from the negative electrode 140 and lithium ions from the separator 120 and/or the electrolyte solution. The buffering function layer 130 is fibrous or porous and accordingly, it has solid portions having ionic conductivity and electronic conductivity and pore portions composed of spaces between the solid portions. In the buffering function layer 130, therefore, the electrons and lithium ions supplied as described above react on the surface of the aforesaid solid portion, which is inside the buffering function layer, and a lithium metal precipitates in the pore portion. The term “solid portion” in the buffering function layer as used herein embraces a semisolid such as gel.

In a conventional lithium secondary battery, the precipitation site of a lithium metal is limited to the surface of a negative electrode and therefore, the growth direction of the lithium metal is limited to from the surface of the negative electrode to the separator and the lithium metal tends to grow into dendrite form. In a lithium secondary battery having a buffering function layer such as the lithium secondary battery 100 of the present embodiment, on the other hand, a lithium metal precipitates not only on the surface of the negative electrode but also on the surface of the solid portion of the buffering function layer, leading to an increase in the surface area of the reaction site of a lithium metal precipitation reaction. As a result, it is presumed that since in the lithium secondary battery 100, the reaction rate of the lithium metal precipitation reaction is controlled to be mild and anisotropic growth of a lithium metal, that is, formation of a lithium metal which has grown into dendrite form is suppressed, the lithium secondary battery has an excellent cycle characteristic. The factor that makes the lithium secondary battery 100 excellent in cycle characteristic is however not limited to the aforesaid one.

As described above, in the lithium secondary battery 100 of the present embodiment, a lithium metal precipitates not only on the surface of the negative electrode but also on the surface of the solid portion of the buffering function layer 130 so as to fill the pore portion of the buffering function layer with the lithium metal. In the lithium secondary battery 100, the buffering function layer 130 therefore functions as a buffer layer for suppressing the volume expansion of the battery caused by charging/discharging. Described specifically, charging of a conventional lithium secondary battery not having a buffering function layer causes precipitation of a lithium metal on the surface of the negative electrode and the battery after charging has an expanded cell volume compared with the battery before charging. On the other hand, in the lithium secondary battery 100 of the present embodiment, expansion of the cell volume of the battery by charging can be suppressed because a lithium metal precipitates not only on the surface of the negative electrode but also in the pore portion of the buffering function layer 130. The lithium secondary battery of the present embodiment is therefore particularly useful as a battery whose permissible volume expansion ratio is small (for example, battery for compact electronic device or the like).

The buffering function layer 130 is not particularly limited insofar as it is fibrous or porous and has ionic conductivity and electronic conductivity. Non-limiting examples of the buffering function layer include those obtained by covering all or some of the surface of a fibrous or porous ionically conductive layer with an electronically conductive layer, those obtained by covering all or some of the surface of a fibrous or porous electronically conductive layer with an ionically conductive layer, and those obtained by entwining a fibrous ionically conductive layer and a fibrous electronically conductive layer.

The ionically conductive layer is not limited insofar as it is a layer capable of conducting ions and examples include solid electrolytes and pseudo-solid electrolytes (which will also be called “gel electrolytes”, hereinafter) containing an inorganic or organic salt.

The solid electrolyte and gel electrolyte are not particularly limited insofar as they are used generally in a lithium secondary battery and known materials can be selected for them as needed. The resin included in the solid electrolyte or gel electrolyte is not particularly limited and examples include resins having an ethylene oxide unit in the main chain and/or side chain, such as polyethylene oxide (PEO), acrylic resins, vinyl resins, ester resins, nylon resins, polyvinylidene fluoride (PVDF), polyacrylonitrile (PAN), polysiloxane, polyphosphazene, poly(methyl methacrylate), polyamide, polyimide, aramid, polylactic acid, polyethylene, polystyrene, polyurethane, polypropylene, polybutylene, polyacetal, polysulfone, and polytetrafluoroethylene. One or more of the aforesaid resins may be used either singly or in combination.

Examples of the salt contained in the solid electrolyte or gel electrolyte include salts of Li, Na, K, Ca, or Mg. The lithium salt is not particularly limited and examples include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(C₂O₄)₂, LiB(O₂C₂H₄)F₂, LiB(OCOCF₃)₄, LiNO₃, and Li₂SO₄. One or more of the aforesaid salts or lithium salts may be used either singly or in combination.

The content ratio of the lithium salt to the resin in the solid electrolyte or gel electrolyte may be determined by a ratio ([Li]/[O]) of lithium atoms which the lithium salt has to oxygen atoms which the resin has. The content ratio of the lithium salt to the resin in the solid electrolyte or gel electrolyte may be adjusted so that the ratio ([Li]/[O]) be 0.02 or more and 0.20 or less, 0.03 or more and 0.15 or less, or 0.04 or more and 0.12 or less.

The solid electrolyte or gel electrolyte may contain, in addition to the resin and the salt, the electrolyte solution which the lithium secondary battery 100 may contain.

The electronically conductive layer is not limited insofar as it is capable of conducting electrons and examples include metal films and porous metal layers. Non-limiting examples of the metal which may be contained in the electronically conductive layer include SUS, Si, Sn, Sb, Al, Ni, Cu, Sn, Bi, Ag, Au, Pt, Pb, Zn, In, Bi—Sn, and In—Sn. As the metal to be contained in the electronically conductive layer, Cu and Ni are preferred. The electronically conductive layer may contain one of the aforesaid metals singly or two or more of these metals as an alloy.

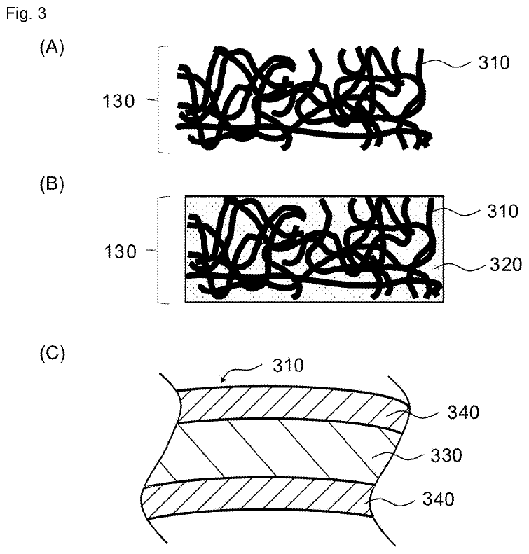

One embodiment of the buffering function layer 130 is a fibrous buffering function layer. FIG. 3(A) is a schematic cross-sectional view of a fibrous buffering function layer. The buffering function layer 130 shown in FIG. 3(A) is composed of an ionically and electronically conductive fiber 310 which is a fiber having ionic conductivity and electronic conductivity. Described specifically, the term “the buffering function layer is fibrous” in the present embodiment means that the buffering function layer contains a fiber or is composed of a fiber so that it has solid portions and pore portions composed of a space between the solid portions.

When the lithium secondary battery having the buffering function layer 130 as shown in FIG. 3(A) is charged, a lithium metal precipitates on the surface of the solid portion of the buffering function layer, that is, on the surface of the ionically and electronically conductive fiber 310. In such a mode, therefore, as shown by its schematic cross-sectional view in FIG. 3(B), a lithium metal 320 precipitates on the surface of the ionically and electronically conductive fiber 310, which is a solid portion of the buffering function layer, to fill the pore portion of the buffering function layer with the lithium metal.

FIG. 3(C) is a schematic cross-sectional view showing one embodiment of the ionically and electronically conductive fiber 310. As shown in FIG. 3(C), in this embodiment, the ionically and electronically conductive fiber 310 has a fibrous ionically conductive layer 330 and an electronically conductive layer 340 which covers the surface of the ionically conductive layer 330 therewith. It is presumed that in such a mode, a lithium ion in the ionically conductive layer 330 causes a reduction reaction by electrons supplied from the electronically conductive layer 340 to cause precipitation of a lithium metal. It is also presumed that the lithium metal thus precipitated releases electrons to the electronically conductive layer 340 and is dissolved as a lithium ion in the ionically conductive layer 330 or the electrolyte solution.

The ionically conductive layer 330 may have, for example, the constitution as above as the ionically conductive layer, and the electronically conductive layer 340 may have, for example, the constitution as above as the electronically conductive layer.

The fibrous ionically conductive layer 330 has an average fiber diameter of preferably 20 nm or more and 5000 nm or less, more preferably 30 nm or more and 2000 nm or less, still more preferably 40 nm or more and 1000 nm or less, and still more preferably 50 nm or more and 500 nm or less. When the average fiber diameter of the ionically conductive layer falls within the aforesaid range, the surface area of a reaction site on which a lithium metal precipitates is in a more appropriate range and the resulting lithium secondary battery therefore tends to have a more improved cycle characteristic.

The average thickness of the electronically conductive layer 340 is preferably 1 nm or more and 300 nm or less, more preferably 5 nm or more and 250 nm or less, and still more preferably 10 nm or more and 200 nm or less. When the electronically conductive layer has an average thickness within the aforesaid range, the ionically and electronically conductive fiber 310 can keep its electronic conductivity more appropriately and therefore, the resulting lithium secondary battery tends to have a more improved cycle characteristic.

In another embodiment, the buffering function layer 130 of the lithium secondary battery 100 shown in FIG. 1 may be porous. The porous buffering function layer may have, for example, a porous ionically conductive layer, particularly, an ionically conductive layer having a continuous pore and an electronically conductive layer which covers the surface of the ionically conductive layer.

The buffering function layer is fibrous or porous and accordingly, it has pores. The porosity of the buffering function layer is not particularly limited and it is preferably 50% or more, more preferably 70% or more, still more preferably 75% or more, and still more preferably 80% or more, each in terms of vol %. When the buffering function layer has a porosity in the aforesaid preferable range, the surface area of a reaction site where the lithium metal can precipitate shows a further increase, so that the resulting lithium secondary battery has a more improved cycle characteristic. Such a mode tends to exhibit an effect of suppressing the cell volume expansion more effectively and reliably. The porosity of the buffering function layer is not particularly limited and it may be 99% or less, 95% or less, or 90% or less in terms of vol. %

The average thickness of the buffering function layer is preferably 100 μm or less, more preferably 50 μm or less, and still more preferably 30 μm or less. When the buffering function layer has an average thickness in the aforesaid range, an occupation volume of the buffering function layer 130 in the lithium secondary battery 100 decreases and the resulting battery has a more improved energy density. In addition, the average thickness of the buffering function layer is preferably 1 μm or more, more preferably 4 μm or more, and still more preferably 7 μm or more. When the buffering function layer has an average thickness in the aforesaid range, the surface area of a reaction site in which a lithium metal can precipitate shows a further increase so that the resulting battery tends to have a more improved cycle characteristic. Such a mode tends to exhibit an effect of suppressing the cell volume expansion more effectively and reliably.

The fiber diameter of the fibrous ionically conductive layer, the thickness of the electronically conductive layer, the porosity of the buffering function layer, and the thickness of the buffering function layer can be measured by known measurement methods. For example, the thickness of the buffering function layer can be determined by etching the surface of the buffering function layer by focused ion beam (FIB) to expose the section thereof and observing the thickness of the buffering function layer at the exposed section by SEM or TEM.

The fiber diameter of the fibrous ionically conductive layer, the thickness of the electronically conductive layer, and the porosity of the buffering function layer can be determined by observing the surface of the buffering function layer by a transmission electron microscope. The porosity of the buffering function layer may be calculated by subjecting the observed image of the surface of the buffering function layer to binary analysis with an image analysis software and finding a proportion of the buffering function layer in the total area of the image.

The aforesaid measurement values are each calculated by finding the average of the values measured three times or more, preferably 10 times or more.

When the buffering function layer contains a metal reactive with lithium, the total capacity of the negative electrode 140 and the buffering function layer 130 is sufficiently small relative to the capacity of the positive electrode 110 and for example, it may be 20% or less, 15% or less, 10% or less, or 5% or less.

(Electrolyte Solution)

The lithium secondary battery 100 may have electrolyte solution. The separator 120 may be wetted with the electrolyte solution or the lithium secondary battery 100 may be sealed with the electrolyte solution to obtain a finished product. The electrolyte solution contains an electrolyte and a solvent. It is a solution having ionic conductivity and serves as a conductive path of a lithium ion. The lithium secondary battery 100 having the electrolyte solution therefore has a more reduced internal resistance and a more improved energy density, capacity, and cycle characteristic.

The electrolyte is not particularly limited insofar as it is a salt and examples include salts of Li, Na, K, Ca, or Mg. As the electrolyte, a lithium salt is preferred. The lithium salt is not particularly limited and examples include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. The lithium salt is preferably LiN(SO₂F)₂ from the standpoint of providing a lithium secondary battery 100 having more excellent energy density, capacity, and cycle characteristic. One or more of the aforesaid lithium salts may be used either singly or in combination.

The solvent is not particularly limited and examples include dimethyl ether, diethylene glycol dimethyl ether, triethylene glycol dimethyl ether, acetonitrile, dimethyl carbonate, diethyl carbonate, ethyl methyl carbonate, ethylene carbonate, propylene carbonate, chloroethylene carbonate, fluoroethylene carbonate, difluoroethylene carbonate, trifluoromethyl propylene carbonate, methyl acetate, ethyl acetate, propyl acetate, methyl propionate, ethyl propionate, nonafluorobutyl methyl ether, nonafluorobutyl ethyl ether, tetrafluoroethyl tetrafluoropropyl ether, trimethyl phosphate, and triethyl phosphate. One or more of the aforesaid solvents may be used either singly or in combination.

(Use of a Lithium Secondary Battery)

FIG. 2 shows one mode of the use of the lithium secondary battery of the present embodiment. In the lithium secondary battery 200, a positive electrode terminal 220 and a negative electrode terminal 210 for connecting a lithium secondary battery to an external circuit are bonded the positive electrode current collector 150 and the negative electrode 140 of the lithium secondary battery 100, respectively. The lithium secondary battery 200 is charged/discharged by connecting the negative electrode terminal 210 to one end of the external circuit and the positive electrode terminal 220 to the other end of the external circuit.

The lithium secondary battery 200 may have a solid electrolyte interfacial layer (SEI layer) on the surface of the negative electrode 140 (interface between the negative electrode 140 and the buffering function layer 130) by the initial charge. The lithium secondary battery may not have the SEI layer or may have it on the surface of the solid portion of the buffering function layer 130. The SEI layer to be formed is not particularly limited and it may contain a lithium-containing inorganic compound or a lithium-containing organic compound. The typical average thickness of the SEI layer is 1 nm or more and 10 μm or less.

The lithium secondary battery 200 is charged by applying a voltage between the positive electrode terminal 220 and the negative electrode terminal 210 to cause a current flow from the negative electrode terminal 210 to the positive electrode terminal 220 through the external circuit. When the lithium secondary battery 200 is charged, precipitation of a lithium metal occurs on the surface of the negative electrode. The precipitation of the lithium metal occurs on at least one of the surface of the negative electrode 140 (interface between the negative electrode 140 and the buffering function layer 130) and the inside of the buffering function layer 130 (surface of the solid portion of the buffering function layer 130).

When the positive electrode terminal 220 and the negative electrode terminal 210 are connected to the charged lithium secondary battery 200, the lithium secondary battery 200 is discharged. This discharge causes electrolytically dissolving of the precipitated lithium metal on the surface of the negative electrode.

(Method of Manufacturing a Lithium Secondary Battery)

A method of manufacturing the lithium secondary battery 100 as shown in FIG. 1 is not particularly limited insofar as it can provide a lithium secondary battery equipped with the aforesaid structure and examples of the method include the method as follows.

First, the positive electrode 110 is prepared by using a known producing method or purchasing a commercially available one. The positive electrode 110 is prepared, for example, in the following manner. The aforesaid positive-electrode active material, a known conductive additive, and a known binder are mixed to obtain a positive electrode mixture. The mixing ratio of them in the total amount of the positive electrode mixture may be adjusted so that the contents of the positive-electrode active material, conductive additive, and binder are, for example, 50 mass % or more and 99 mass % or less, 0.5 mass % or more and 30 mass % or less, and 0.5 mass % or more and 30 mass % or less, respectively. The positive electrode mixture thus obtained is applied to one of the surfaces of a metal foil (for example, Al foil) serving as a positive electrode current collector and having a predetermined thickness (for example, 5 μm or more and 1 mm or less), followed by press molding. The molded product thus obtained is punched into a predetermined size to obtain a positive electrode 110.

Next, the aforesaid negative electrode material, for example, a metal foil (such as an electrolytic Cu foil) having a thickness of 1 μm or more and 1 mm or less is washed with a sulfamic-acid-containing solvent, punched into a predetermined size, ultrasonically washed with ethanol, and then dried to obtain a negative electrode 140.

Next, a separator 120 having the aforesaid constitution is prepared. As the separator 120, a separator produced by a conventionally known method or a commercially available one may be used.

The method of manufacturing a buffering function layer 130 is not particularly limited insofar it can provide a fibrous or porous layer having ionic conductivity and electronic conductivity and for example, the method may be performed as follows.

A fibrous buffering function layer, which is one as shown in FIG. 3(C), having an ionically and electronically conductive fiber 310 which has a fibrous ionically conductive layer 330 and an electronically conductive layer 340 covering the surface of the ionically conductive layer 330 can be produced as follows.

First, a solution obtained by dissolving the aforesaid resin (for example, PVDF) in an appropriate organic solvent (for example, N-methylpyrrolidone) is applied with a doctor blade onto the surface of the separator 120 prepared in advance. The separator 120 having the resin solution applied thereto is immersed in a water bath and then dried sufficiently at room temperature to form a fibrous ionically conductive layer on the separator 120 (the ionically conductive layer may be allowed to exhibit its ionically conductive function, for example, by pouring an electrolyte solution at the time of assembly of a battery). Then, an appropriate metal (for example, Ni) is deposited under vacuum conditions on the separator having the fibrous ionically conductive layer formed thereon to obtain a fibrous buffering function layer.

In the method of preparing a fibrous buffering function layer, the porosity of the buffering function layer can be controlled, for example, by adjusting the average fiber diameter of the fibrous ionically conductive layer. For example, with a decrease in the average fiber diameter, the buffering function layer tends to have a larger porosity. The average fiber diameter of the fibrous ionically conductive layer can be controlled by adjusting, in the aforesaid method, the concentration of the resin in the resin solution to be applied onto the surface of the separator, an immersion time of the separator in a water bath, or the like.

The porous buffering function layer having a porous ionically conductive layer and an electronically conductive layer which covers the surface of the ionically conductive layer can also be produced as follows.

First, by using a solution obtained by dissolving the aforesaid resin (for example, PVDF) in an appropriate solvent (for example, N-methylpyrrolidone), a porous ionically conductive layer having a continuous pore is formed on the surface of the separator 120 by a conventionally known method (for example, a method using phase separation from solvent, a method using a foaming agent, or the like) (the ionically conductive layer may be allowed to exhibit its ion conductive function, for example, by pouring an electrolyte solution at the time of the assembly of a battery). Then, by depositing an appropriate metal (for example, Ni), under vacuum conditions, on the separator having the porous ionically conductive layer formed thereon, a porous buffering function layer can be obtained.

The positive electrode 110, the separator 120 having the buffering function layer 130 formed thereon, and the negative electrode 140, each obtained as described above, are stacked in order of mention so that the buffering function layer 130 faces the negative electrode 140 and thus, a stacked body is obtained. The stacked body thus obtained is encapsulated, together with the electrolyte solution in a hermetically sealing container to obtain a lithium secondary battery 100. The hermetically sealing container is not particularly limited and examples include a laminate film.

### Second Embodiment

### (Lithium Secondary Battery)

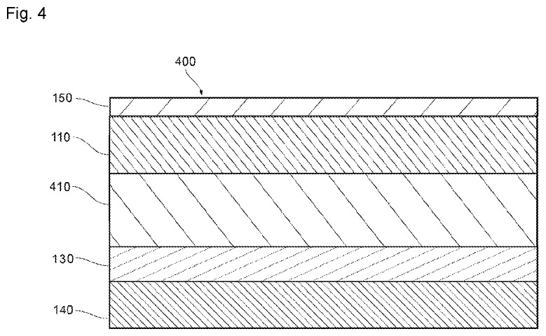

FIG. 4 is a schematic cross-sectional view of a lithium secondary battery of Second Embodiment. As shown in FIG. 4, the lithium secondary battery 400 of Second Embodiment includes the positive electrode 110, the negative electrode 140 not having a negative-electrode active material, a solid electrolyte 410 placed between the positive electrode 110 and the negative electrode 140, and a fibrous or porous buffering function layer 130 placed on the surface of the solid electrolyte 410 facing the negative electrode 140, the buffering function layer having ionic conductivity and electronic conductivity. The positive electrode 110 has a positive electrode current collector 150 on the surface thereof opposite to the surface facing the solid electrolyte 410.

The respective constitutions and preferred modes of the positive electrode current collector 150, the positive electrode 110, the buffering function layer 130, and the negative electrode 140 are similar to those of the lithium secondary battery 100 of First Embodiment and these components of the lithium secondary battery 400 have similar effects to those of the lithium secondary battery 100.

(Solid Electrolyte)

In general, a battery having a liquid electrolyte tends to be exposed to different physical pressures, which are applied from the electrolyte to the surface of a negative electrode, at different locations due to the shaking of the liquid. On the other hand, since the lithium secondary battery 400 has the solid electrolyte 410, a pressure applied from the solid electrolyte 410 to the surface of the negative electrode 140 becomes more uniform and the shape of a lithium metal precipitated on the surface of the negative electrode 140 can be made more uniform. This means that in such a mode, a lithium metal which precipitates on the surface of the negative electrode 140 is suppressed further from growing into dendrite form and the resulting lithium secondary battery 400 therefore has a more excellent cycle characteristic.

The solid electrolyte 410 is not particularly limited insofar as it is used generally for a lithium solid secondary battery and a known material can be selected as needed, depending on the use of the lithium secondary battery 400. The solid electrolyte 410 preferably has ionic conductivity and has no electronic conductivity. Since the solid electrolyte 410 has ionic conductivity and has no electronic conductivity, the resulting lithium secondary battery 400 has more reduced internal resistance and in addition, the lithium secondary battery 400 is prevented from causing a short circuit inside thereof. As a result, the lithium secondary battery 400 has a more excellent energy density, capacity, and cycle characteristic.

The solid electrolyte 410 is not particularly limited and examples include those containing a resin and a lithium salt. The resin is not particularly limited and examples include those given as the examples of the resin which can be contained in the ionically conductive layer of the buffering function layer 130. The lithium salt is not particularly limited and examples include those given as the examples of the lithium salt which can be contained in the ionically conductive layer of the buffering function layer 130. One or more of the aforesaid resins or lithium salts may be used either singly or in combination.

With respect to a content ratio of the lithium salt to the resin in the solid electrolyte 410, the aforesaid ratio ([Li]/[O]) is preferably 0.02 or more and 0.20 or less, more preferably 0.03 or more and 0.15 or less, and still more preferably 0.04 or more and 0.12 or less.

The solid electrolyte 410 may contain a component other than the aforesaid resin and lithium salt. Such a component is not particularly limited and examples include solvents and salts other than lithium salts. The salts other than lithium salts are not particularly limited and examples include salts of Na, K, Ca, and Mg.

The solvent is not particularly limited and examples include those given as the solvent of the electrolyte solution which can be contained in the aforesaid lithium secondary battery 100.

The average thickness of the solid electrolyte 410 is preferably 20 μm or less, more preferably 18 μm or less, and still more preferably 15 μm or less. In such a mode, an occupation volume of the solid electrolyte 410 in the lithium secondary battery 400 decreases so that the resulting lithium secondary battery 400 has a more improved energy density. The average thickness of the solid electrolyte 410 is preferably 5 μm or more, more preferably 7 μm or more, and still more preferably 10 μm or more. In such a mode, the positive electrode 110 can be separated from the negative electrode 140 more reliably and a short circuit of the resulting battery can be suppressed further.

The solid electrolyte 410 embraces a gel electrolyte. The gel electrolyte is not particularly limited and examples include those containing a polymer, an organic solvent, and a lithium salt. The polymer in the gel electrolyte is not particularly limited and examples include copolymers of polyethylene and/or polyethylene oxide, polyvinylidene fluoride, and copolymers of polyvinylidene fluoride and hexafluoropropyrene.

(Method of Manufacturing a Secondary Battery)

The lithium secondary battery 400 can be manufactured in a manner similar to that of the lithium secondary battery 100 of First Embodiment except for the use of the solid electrolyte instead of the separator.

The method of manufacturing a solid electrolyte 410 is not particularly limited insofar as it is a method capable of providing the aforesaid solid electrolyte 410 and it may be performed, for example, as follows. A resin and a lithium salt conventionally used for a solid electrolyte (for example, the aforesaid resin as a resin which can be contained in the solid electrolyte 410, and a lithium salt) are dissolved in an organic solvent (for example, N-methylpyrrolidone or acetonitrile). The solution thus obtained is cast on a molding substrate to have a predetermined thickness and thus, a solid electrolyte 410 is obtained. The mixing ratio of the resin and the lithium salt may be determined, as described above, based on a ratio ([Li]/[O]) of lithium atoms of the lithium salt to oxygen atoms of the resin. The ratio ([Li]/[O]) is, for example, 0.02 or more and 0.20 or less. The molding substrate is not particularly limited and, for example, a PET film or a glass substrate may be used.

### MODIFICATION EXAMPLE

The aforesaid embodiments are examples for describing the present invention. They do not intend to limit the present invention only thereto and the present invention may have various modifications without departing from the gist thereof.

For example, the lithium secondary battery 100 of First Embodiment may have separators 120 on both sides of the negative electrode 140. In this case, the lithium secondary battery has a structure in which the following components are stacked in order of mention: positive electrode/separator/buffering function layer/negative electrode/buffering function layer/separator/positive electrode. The lithium secondary battery in such a mode has more improved capacity. The lithium secondary battery 400 of Second Embodiment may have a similar stacked structure.

The lithium secondary battery of the present embodiment may be a lithium solid secondary battery. A battery in such a mode does not need electrolyte solution so that it is free from a problem of electrolyte solution leakage and has more improved safety.

The lithium secondary battery of the present embodiment may or may not have a lithium foil between the separator or solid electrolyte and the negative electrode before initial charging. The lithium secondary battery of the present embodiment not having a lithium foil between the separator or solid electrolyte and the negative electrode before initial charging has more excellent safety and productivity because use of a lithium metal having high flammability is not required in the manufacture of the battery.

The lithium secondary battery of the present embodiment may or may not have a current collector which is to be placed on the surface of the negative electrode and/or positive electrode so as to be in contact with the negative electrode or positive electrode. Such a current collector is not particularly limited and examples include those usable as a negative electrode material. When the lithium secondary battery has neither a positive electrode current collector nor a negative electrode current collector, the positive electrode and the negative electrode themselves serve as current collectors, respectively.

The lithium secondary battery of the present embodiment may have, at the positive electrode and/or negative electrode, a terminal for connecting it to an external circuit. For example, a metal terminal (for example, Al, Ni, or the like) having a length of 10 μm or more and 1 mm or less may be bonded to one or both of the positive electrode current collector and the negative electrode. For bonding, a conventionally known method may be used and for example, ultrasonic welding is usable.

The term “an energy density is high” or “has a high energy density” as used herein means that the capacity of a battery per total volume or total mass is high. It is preferably 800 Wh/L or more or 350 Wh/kg or more, more preferably 900 Wh/L or more or 400 Wh/kg or more, and still more preferably 1000 Wh/L or more or 450 Wh/kg or more.

The term “having an excellent cycle characteristic” as used herein means that a decreasing ratio of the capacity of a battery is small before and after the expected number of charging/discharging cycles in ordinary use. Described specifically, it means that when a first discharge capacity after the initial charging/discharging and a capacity after the number of charging/discharging cycles expected in ordinary use are compared, the capacity after charging/discharging cycles has hardly decreased compared with the first discharge capacity after the initial charging/discharging. The “number expected in ordinary use” varies depending on the usage of the lithium secondary battery and it is, for example, 30 times, 50 times, 70 times, 100 times, 300 times, or 500 times. The term “capacity after charging/discharging cycles hardly decreased compared with the first discharge capacity after the initial charging/discharging” means, though differing depending on the usage of the lithium secondary battery, that the capacity after charging/discharging cycles is, for example, 60% or more, 65% or more, 70% or more, 75% or more, 80% or more, or 85% or more, each in the first discharge capacity after the initial charging/discharging.

### EXAMPLES

The present invention will hereinafter be described in detail by Examples and Comparative Examples. The present invention is not limited by the following Examples.

### Example 1

A lithium secondary battery was manufactured in the following manner.

(Formation of Negative Electrode)

A negative electrode was obtained by washing a 10-μm electrolytic Cu foil with a solvent containing sulfamic acid, punching the resulting foil into a predetermined size (45 mm×45 mm), ultrasonically washing it with ethanol, and then drying it.

(Formation of Separator)

As a separator, that obtained by coating the both sides of a 12-μm polyethylene microporous membrane with 2-μm polyvinylidene fluoride (PVDF), which had a thickness of 16 μm and a predetermined size (50 mm×50 mm), was formed.

(Formation of Positive Electrode)

A mixture of 96 parts by mass of LiNi_{0.85}Co_{0.12}Al_{0.03}O₂ as a positive-electrode active material, 2 parts by mass of carbon black as a conductive additive, and 2 parts by mass of polyvinylidene fluoride (PVDF) as a binder was applied onto one side of a 12-μm Al foil serving as a positive electrode current collector, followed by pressing molding. The molded product thus obtained was punched into a predetermined size (40 mm×40 mm) by punching to obtain a positive electrode.

(Formation of Buffering Function Layer)

A resin solution obtained by dissolving a PVDF resin in N-methylpyrrolidone (NMP) was applied onto the separator with a doctor blade. The separator onto which the resin solution was applied was immersed in a water bath and then dried sufficiently at room temperature to form a fibrous ionically conductive layer on the separator (it is to be noted that the ionically conductive layer becomes ionically conductive function when an electrolyte solution (a 4M dimethoxyethane (DME) solution of LiN(SO₂F)₂(LFSI)) which will be described later is poured at the time of battery assembly).

The average fiber diameter of the fibrous ionically conductive layer formed on the separator was observed and measured with a scanning electron microscope (SEM) to be 100 nm.

Then, Ni was deposited under vacuum conditions on the separator having a fibrous ionically conductive layer formed thereon. The ionically conductive layer deposited with Ni was observed with an SEM equipped with an energy dispersion type X-ray analyzer (EDX). It was confirmed that the Ni was distributed so as to cover the fibrous ionically conductive layer and that a fibrous buffering function layer covered at the surface of the fibrous ionically conductive layer with the electronically conductive layer was obtained.

The section of the buffering function layer prepared using FIB was observed by SEM and the average thickness of the buffering function layer was found to be 10 μm. As a result of the observation of the buffering function layer with a transmission electron microscope, the average thickness of the thin Ni film, that is, the electronically conductive layer and the porosity of the buffering function layer were found to be 20 nm and 90%, respectively.

(Assembly of Battery)

As electrolyte solution, 4M dimethoxyethane (DME) solution of LiN(SO₂F)₂(LFSI) was prepared.

Then, a stacked body was obtained by stacking the positive electrode, the separator having a buffering function layer thereon, and the negative electrode in order of mention. Further, a 100-μm Al terminal and a 100-μm Ni terminal were bonded to the positive electrode and the negative electrode, respectively by ultrasonic welding and then the bonded body was inserted into a laminate-film outer container. Then, the electrolyte solution was poured in the outer container. The resulting outer container was hermetically sealed to obtain a lithium second battery.

### Example 2

In a manner similar to that of Example 1 except that the deposition time of Ni was changed in the step of forming the buffering function layer, a lithium secondary battery was obtained. As a result of the observation of the buffering function layer with a transmission electron microscope, the average thickness of the thin Ni film serving as the electronically conductive layer was 200 nm.

### Examples 3 to 6

In a manner similar to that of Example 1 except that the metal to be deposited as the electronically conductive layer was changed from Ni to Cu and a deposition time of the metal was changed in the step of forming the buffering function layer, lithium secondary batteries were obtained. As a result of the observation of the buffering function layer with a transmission electron microscope, the average thickness of the thin Cu film serving as the electronically conductive layer was as described in Table 1. In the step of forming the buffering function layer, a fibrous ionically conductive layer was formed by adjusting the concentration of a PVDF resin in the resin solution and the immersion time of the separator in a water bath so as to have an average thickness and porosity of the buffering function layer and an average fiber diameter of the ionically conductive layer as listed in Table 1.

### Examples 7 to 10

In a manner similar to Example 1, a negative electrode and a positive electrode were formed. As a separator, that having a thickness of 26 μm and a predetermined size (50 mm×50 mm) was formed by coating both of the surfaces of a 22-μm polyethylene microporous membrane with 2-μm polyvinylidene fluoride (PVDF).

In a manner similar to Example 1, a fibrous ionically conductive layer was formed on the separator. By adjusting the concentration of the resin in the resin solution applied onto the surface of the separator, immersion time of the separator in a water bath, and application amount of the resin solution as needed, the average thickness and the porosity of the buffering function layer and the average fiber diameter of the ionically conductive layer were controlled to values as described in Table 1.

Then, each metal (Ni or Cu) described in Table 1 was deposited under vacuum conditions on the separator having the fibrous ionically conductive layer formed thereon. During deposition, the deposition time was adjusted so that the average thickness of the thin metal film (thin Ni film or thin Cu film) serving as the electronically conductive layer be a value as described in Table 1.

In a manner similar to that of Example 1 by using the positive electrode, the separator having the buffering function layer formed thereon, and the negative electrode, each obtained as described above, lithium secondary batteries were obtained

### Comparative Example 1

In a manner similar to that of Example 1 except that a buffering function layer was not formed on the surface of the separator, a lithium secondary battery was obtained.

### Comparative Example 2

In a manner similar to that of Example 7 except that a buffering function layer was not formed on the surface of the separator, a lithium secondary battery was obtained.

### Comparative Example 3

In a manner similar to that of Example 1 except that Ni deposition was not performed in the step of forming a buffering function layer, a lithium secondary battery was obtained. In the present Comparative Example, therefore, only a fibrous ionically conductive layer was formed on the surface of the separator and the ionically conductive layer does not have electronic conductivity. The average fiber diameter, average thickness, and porosity of the ionically conductive layer were measured with a scanning electron microscope (SEM), FIB and SEM, and a transmission electron microscope to be 100 nm, 10 μm, and 90%, respectively. The average thickness and porosity of the ionically conductive layer are described as “average thickness of buffering function layer” and “porosity of buffering function layer”, respectively, in Table 1.

[Evaluation of Energy Density and Cycle Characteristic]

The energy density and cycle characteristic of each of the lithium secondary batteries manufactured in Examples and Comparative Examples were evaluated as follows.

After each of the lithium secondary batteries thus manufactured was charged (initial charge) at 3.2 mA to a voltage of 4.2 V, it was discharged at 3.2 mA to a voltage of 3.0 V (which will hereinafter be called “initial discharge”). Then, a charge/discharge cycle consisting of charging at 6.4 mA to a voltage of 4.2 V and discharging at 6.4 mA to a voltage of 3.0 V was repeated at a temperature condition of 25° C. In any of Examples and Comparative Examples, the capacity determined from the initial discharge (which will hereinafter called “initial capacity”) was 64 mAh and the volume area density was 4.0 mAh/cm². In each Example, the number of cycles when the discharge capacity reached 80% of the initial capacity (called “number of cycles at 80%” in the table) is shown in Table 1.

[Measurement of Volume Expansion Ratio]

In each Example, by measuring the thickness of a cell rightly after manufacture, the thickness of a cell after initial charge, and the thickness of a cell after 100th charge after the aforesaid charge/discharge cycle was performed 99 times, a volume expansion ratio caused by charge/discharge was measured. A volume expansion ratio of a cell after initial charge relative to a cell rightly after manufacture (meaning that how much the cell after initial charge expands relative to the cell rightly after manufacture), and a volume expansion ratio of a cell after 100th charge relative to a cell rightly after manufacture (meaning that how much the cell after 100th charge expands relative to the cell rightly after manufacture) are described in Table 1 as a volume expansion ratio (first cycle) (%) and a volume expansion ratio (100th cycle) (%), respectively.

TABLE 1

| | | Buffering function layer | | | | | | Volume | Volume | |
|---|---|---|---|---|---|---|---|---|---|---|
| | | | | Fibrous ionically | | Electronically | | expansion | expansion | |
| | Separator | | | conductive layer | | conductive layer | | ratio | ratio | Number |
| | Average | Average | | | Average | | Average | (first | (100th | of cycles |
| Sample | thickness | thickness | Porosity | | diameter | | thickness | cycle) | cycle) | at 80% |
| No. | (μm) | (μm) | (%) | Material | (nm) | Material | (nm) | (%) | (%) | (times) |
| Ex. 1 | 16 | 10 | 90 | PVDF | 100 | Ni | 20 | 12 | 20 | 112 |
| Ex. 2 | 16 | 10 | 90 | PVDF | 100 | Ni | 200 | 12 | 22 | 130 |
| Ex. 3 | 16 | 10 | 85 | PVDF | 50 | Cu | 10 | 15 | 23 | 120 |
| Ex. 4 | 16 | 10 | 85 | PVDF | 50 | Cu | 100 | 15 | 25 | 137 |
| Ex. 5 | 16 | 10 | 70 | PVDF | 200 | Cu | 10 | 16 | 26 | 105 |
| Ex. 6 | 16 | 10 | 50 | PVDF | 200 | Cu | 10 | 15 | 29 | 85 |
| Ex. 7 | 26 | 20 | 90 | PVDF | 100 | Ni | 20 | 5 | 8 | 115 |
| Ex. 8 | 26 | 20 | 90 | PVDF | 100 | Ni | 200 | 6 | 9 | 125 |
| Ex. 9 | 26 | 20 | 85 | PVDF | 50 | Cu | 10 | 7 | 10 | 130 |
| Ex. 10 | 26 | 20 | 85 | PVDF | 50 | Cu | 100 | 7 | 11 | 135 |
| Comp. | 16 | — | — | — | — | — | — | 50 | 150 | 45 |
| Ex. 1 | | | | | | | | | | |
| Comp. | 26 | — | — | — | — | — | — | 25 | 105 | 50 |
| Ex. 2 | | | | | | | | | | |
| Comp. | 16 | 10 | 90 | PVDF | 100 | — | — | 14 | 29 | 62 |
| Ex. 3 | | | | | | | | | | |

In Table 1, “-” means that the battery does not have a buffering function layer or electronically conductive layer.

It is apparent from Table 1 that the batteries of Examples 1 to 10 having a fibrous or porous buffering function layer which has ionic conductivity and electronic conductivity are high in the number of cycles at 80% and therefore have an excellent cycle characteristic, compared with those of Comparative Examples 1 to 3 which do not have the buffering function layer. In addition, it is apparent from the comparison between Examples 1 to 10 and Comparative Example 3 that volume expansion is suppressed in Examples 1 to 10 because their buffering function layers have electronic conductivity.

The lithium secondary battery of the present invention has a high energy density and an excellent cycle characteristic and a volume expansion of a cell caused by charge/discharge is suppressed, so that it has industrial applicability as a power storage device to be used for various uses, particularly a battery (for example, battery for a compact electron device or the like) whose permissible volume expansion ratio is small.

100, 200, 400 . . . lithium secondary battery

110 . . . positive electrode

120 . . . separator

130 . . . buffering function layer

140 . . . negative electrode

150 . . . positive electrode current collector

210 . . . negative electrode terminal

220 . . . positive electrode terminal,

310 . . . ionically and electronically conductive fiber

320 . . . lithium metal

330 . . . ionically conductive layer

340 . . . electronically conductive layer

410 . . . solid electrolyte.

What is claimed is:

1. A lithium secondary battery, comprising:
a positive electrode,
a negative electrode not having a negative-electrode active material,
a separator placed between the positive electrode and the negative electrode, and
a fibrous or porous buffering function layer formed on a surface of the separator facing the negative electrode, the buffering function layer having ionic conductivity and electronic conductivity.

2. A lithium secondary battery, comprising:
a positive electrode,
a negative electrode not having a negative-electrode active material,
a solid electrolyte placed between the positive electrode and the negative electrode, and
a fibrous or porous buffering function layer formed on a surface of the solid electrolyte facing the negative electrode, the buffering function layer having ionic conductivity and electronic conductivity.

3. The lithium secondary battery according to claim 1, wherein the buffering function layer has a porosity of 70% or more and 95% or less.

4. The lithium secondary battery according to claim 1, wherein the buffering function layer has a thickness of 1 μm or more and 100 μm or less.

5. the lithium secondary battery according to claim 1, wherein the buffering function layer comprises a fibrous or porous ionically conductive layer and an electronically conductive layer which covers the ionically conductive layer.

6. The lithium secondary battery according to claim 5, wherein the electronically conductive layer has an average thickness of 1 nm or more and 300 nm or less.

7. The lithium secondary battery according to claim 1, wherein the lithium secondary battery is a lithium secondary battery in which charging and discharging are performed by depositing lithium metal on the surface of the negative electrode and electrolytically dissolving the deposited lithium.

8. The lithium secondary battery according to claim 1, wherein the negative electrode is an electrode consisting of at least one selected from the group consisting of Cu, Ni, Ti, Fe, and other metals that do not react with Li, alloys thereof, and stainless steel (SUS).

9. The lithium secondary battery according to claim 1, wherein the negative electrode does not have a lithium foil on the surface thereof before initial charge.

10. the lithium secondary battery according to claim 1, having an energy density of 350 Wh/kg or more.

11. The lithium secondary battery according to claim 2, wherein the buffering function layer has a porosity of 70% or more and 95% or less.

12. The lithium secondary battery according to claim 2, wherein the buffering function layer has a thickness of 1 μm or more and 100 μm or less.

13. The lithium secondary battery according to claim 2, wherein the buffering function layer comprises a fibrous or porous ionically conductive layer and an electronically conductive layer which covers the ionically conductive layer.

14. The lithium secondary battery according to claim 13, wherein the electronically conductive layer has an average thickness of 1 nm or more and 300 nm or less.

15. The lithium secondary battery according to claim 2, wherein the lithium secondary battery is a lithium secondary battery in which charging and discharging are performed by depositing lithium metal on the surface of the negative electrode and electrolytically dissolving the deposited lithium.

16. The lithium secondary battery according to claim 2, wherein the negative electrode is an electrode consisting of at least one selected from the group consisting of Cu, Ni, Ti, Fe, and other metals that do not react with Li, alloys thereof, and stainless steel (SUS).
